(19) United States
(12) Patent Application Publication
(10) Pub. No.: US 2005/0258559 A1
(43) Pub. Date: Nov. 24, 2005

(54) Thermoforming method and apparatus for use in an injection molding machine

(76) Inventors: Loren R. Johansen, Chanhassen, MN (US); Michael D. McElhatton, Kewaskum, WI (US); Michael J. Ruminski, West Bend, WI (US); Daniel L. Dunst, Grafton, WI (US); Kurt F. Eschenfelder, West Bend, WI (US)

Correspondence Address: GODFREY & KAHN S.C., 780 NORTH WATER STREET, MILWAUKEE, WI, 53202, US

(21) Appl. No.: 10/363,154

(22) PCT Filed: Jan. 9, 2001
(86) PCT No.: PCT/US01/00607

§ 371 Date: Jun. 30, 2003

(30) Foreign Application Priority Data
Sep. 1, 2000 (US) 00/23909

(51) Int. Cl. H05B 6/00; B29C 51/10; B29C 45/14

(52) U.S. Cl. 264/40.6; 264/132; 264/553; 264/492; 264/265; 264/161; 264/511; 425/112; 425/126.1; 425/129.1; 425/170; 425/553; 425/174.4; 425/302.1; 425/384

(57) ABSTRACT

A thermoforming method and apparatus for use in an injection molding machine for simultaneously performing the multiple functions of forming, cutting and molding of deep drawn injection molded parts. The thermoforming apparatus includes a forming tool (58) having a former assembly (62) on one side thereof and a heater assembly (64) on the opposite side thereof for thermoforming a printed substrate. The former assembly (62) includes a forming mold coupled to a vacuum source and housed within a pressure vessel. The heater assembly (64) includes heating elements for rapid on/off heating of the substrate, a temperature sensor for continuously monitoring the temperature of the substrate during heating, a pressure vessel coupled to a pressure source and a cooling vessel. The former assembly (62) and heater assembly (64) come together to engage a substrate therebetween.

### CROSS-REFERENCE TO RELATED APPLICATIONS

This application is a continuation-in-part of International Application Serial No. PCT/US00/23909, filed Sep. 1, 2000, which is a continuation-in-part of U.S. application Ser. No. 09/411,292, filed Oct. 4, 1999.

### FIELD OF THE INVENTION

The present invention relates generally to in-mold decorating methods and apparatus for manufacturing deep drawn injection molded parts with printing thereon, sometimes called applique products, and more particularly to a thermoforming method and apparatus for use in an injection molding machine to simultaneously perform the multiple functions of forming, cutting and molding of deep drawn injection molded parts.

### BACKGROUND OF THE INVENTION

Typically, an in-mold decorated part undergoes multiple steps in its production. For example, a substrate may be printed or decorated by applying ink thereto to provide a desired graphic, such as lettering, designs, logos, etc. The printed substrate is then sent to a forming machine, where the substrate is typically manually fed into the forming machine for forming the substrate into a product shape. The formed substrate can then be pattern-cut, e.g. by die cutting, to define the perimeter of a product, remove excess material, or provide cut-outs. The formed and pattern-cut substrate is then typically manually fed into an injection molding machine for molding the formed substrate into a decorated part. During the injection molding process, molten resin is injected into a closed mold containing the substrate. The mold is allowed to cool and then opened to yield an injection molded part integral with the substrate. Further cutting of the substrate may be performed during or after the injection molding process. Various printing layers, decorative graphics, or overlays may be applied to the substrate through known printing methods to yield the final decorated injection molded part. In the case of multiple pieces connected to a common web or matrix sheet substrate, the pattern-cutting step may also separate the pieces from the web to provide separate individual pieces which are typically individually loaded into the injection molding machine.

The cost of such operations is considerable. There are the obvious costs of performing separate forming and injection molding operations, as well as material handling costs between each operation. There are also considerable hidden costs, including the coordination of all of the separate operations involved, i.e., printing, cutting, sending the part to separate stations for forming and molding, as well as labor costs associated with the numerous manual operations included therein. Furthermore, these tasks can slow the manufacturing process by creating troublesome bottlenecks. In addition, the manual nature of these processes can raise quality concerns in the finished products.

Accordingly, a need exists for a method and apparatus which allows an injection molding operation to proceed without the need to perform the pre-injection molding steps such as forming and cutting. In other words, a need exists for a device which accepts a product in sheet or web form and combines the pre-injection molding steps into one continuous feed apparatus, which eliminates the manual labor and expense associated with manufacturing conventional in-mold decorated parts. Further, a need exists for a multi-purpose processing apparatus which allows the steps of forming, cutting, and molding to be performed on a printed or decorated substrate simultaneously at different positions within an injection molding machine.

There are various processes and apparatus known in the art for forming in-mold decorated or applique products. One such process and apparatus is disclosed in applicants' U.S. application Ser. No. 09/411,292, filed Oct. 4, 1999 and International Application Serial No. PCT/US00/40920, filed Sep. 15, 2000, both entitled “Multi-Purpose Processing Apparatus.” These applications, incorporated herein by reference, disclose the use of a double-sided forming tool to emboss or cold form a three-dimensional shape into printed sheet material by mechanical clamping pressure exerted on the double-sided forming tool. The method and apparatus described in the above-identified applications are best suited for forming shallow-drawn applique parts. Another process and apparatus for forming in-mold decorated parts is disclosed in applicants' International Application Serial No. PCT/US00/23909, filed Sep. 1, 2000, entitled “Pressure Forming Method and Apparatus.” This application, incorporated herein by reference, discloses the use of a pressure medium to form medium drawn printed parts against a single-sided forming tool. The present invention uses a thermoforming process and apparatus to shape deep drawn in-mold decorated parts.

Typically, deep drawn formed thermoplastic parts are obtained by vacuum thermoforming or pressure thermoforming. An example of this is shown in U.S. Pat. Nos. 5,108,530 and 5,217,563 to Niebling et al. In the Niebling method, a printed sheet material is heated and placed in a mold to be formed with a high-pressure medium being applied directly to the sheet material to mold it against the contours of the mold.

The present invention relates to improvements to the methods and apparatus set forth above, and to solutions to some of the problems raised or not solved thereby.

### SUMMARY OF THE INVENTION

Therefore, it is an object of the present invention to provide a multi-purpose processing apparatus which allows the use of an injection molding machine to combine the processes of forming, cutting and molding of printed or decorated stock, in sheet or roll form, to produce a finished molded part with integrated three-dimensional graphics and decoration. It is another object of the invention to provide a thermoforming method and apparatus, which overcomes the drawbacks of the prior art. It is a further object of the present invention to provide a vacuum thermoforming process to shape printed and decorated applique. Further, it is also an object of the present invention to provide a thermoforming method and apparatus which include heating elements with rapid on/off heating capability such that the heating elements may remain in close proximity to printed stock during a forming process. It is yet a further object of the present invention to provide a vacuum/pressure thermoforming process and apparatus which includes a temperature sensor to continuously monitor the temperature of printed stock being heated during a forming process. The multi-purpose processing apparatus of the present invention allows for multiple operations to be performed within the injection molding machine, eliminating the need for separate forming or cutting machines and the added costs associated therewith.

The present invention involves an improved thermoforming method and apparatus using improved heating elements and a temperature sensor incorporated within a forming tool of an injection molding machine. It provides an alternative forming method and apparatus from the embossing cold forming process of the invention described in U.S. patent application Ser. No. 09/411,292 and International Application Serial No. PCT/US00/40920 entitled, “Multi-Purpose Processing Apparatus,” the disclosures of which are incorporated herein by reference, and the pressure forming process disclosed in International Application Serial No. PCT/US00/23909 entitled “Pressure Forming Method and Apparatus,” the disclosure of which is also incorporated by reference. The present invention uses a vacuum/pressure thermoforming method and apparatus to shape printed or decorated applique.

The present invention provides a thermoforming apparatus on an injection molding machine for reducing the manufacturing costs associated with manufacturing deep drawn injection molded decorated parts. The present invention utilizes a forming tool including a former assembly attached to a platen on one side of the injection molding machine and a heater assembly attached to a platen on the other side of the injection molding machine. The former assembly and heater assembly are in communication with a cooling source and a pressure/vacuum source to perform the thermoforming operation.

The heater assembly includes a base having at least one heating element and a temperature sensor mounted thereto, a pressure vessel coupled to the base, and a cooling vessel coupled to the pressure vessel. The base, pressure vessel and cooling vessel are all connected together to form one side of the forming tool. The pressure vessel and the cooling vessel preferably include openings extending through their bodies to form one side of a forming chamber. The pressure and cooling vessels are also coupled to a source of cooling fluid for cooling the vessels during the thermoforming process. The pressure vessel is coupled to a pressure source so that a pressure medium may be applied to the forming chamber to enhance forming. The heating elements are preferably carbon halogen infrared heating elements that are used to heat a printed substrate to near the glass transition temperature of the material. The heating elements are designed to provide rapid on/off heating such that a printed substrate to be formed may remain in close proximity to the heating elements throughout the forming process without being overheated or burned. The temperature sensor is preferably an infrared temperature sensor, which monitors the actual temperature of a printed substrate during heating.

The former assembly includes a base with a forming mold interface for removably attaching a forming mold thereto, and a forming vessel connected to the base to form the opposite side of the forming tool. The forming vessel includes an opening extending through its body to form the opposite side of a forming chamber. The forming vessel is also coupled to a source of cooling fluid for cooling the vessel during the thermoforming process. The forming mold is coupled to a pressure/vacuum source so that a vacuum may be applied to the forming mold to enhance forming.

In the present invention, forming is accomplished by bringing the former assembly and heater assembly together to engage a printed substrate to be formed between the surfaces of the assemblies. The heating elements are in close proximity with the substrate to begin heating the substrate to near its glass transition temperature. The temperature sensor monitors the temperature of the substrate and generates a signal to turn off the heating elements when the substrate has reached its glass transition temperature. A forming mold actuator moves the forming mold into position against the heated substrate engaged between the surfaces of the former and heater assemblies. A vacuum is applied to the forming mold to form the heated substrate against the mold. Positive pressure may also be applied to the forming chamber to enhance forming. The substrate is cooled by cooling fluid flowing through the pressure and cooling vessels, and the forming mold. The former assembly and heater assembly are then separated and the formed substrate is advanced to the injection mold.

The thermoforming apparatus is part of a multi-purpose processing apparatus which is able to perform both a forming operation, an injection molding operation and various cutting operations on an injection molding machine. The multi-purpose processing apparatus eliminates the need for a separate forming machine and combines the distinct steps of forming, cutting and injection molding into a single continuous operation performed on an injection molding machine. The multi-purpose processing apparatus allows the three steps of forming, cutting and molding to be performed simultaneously as printed material is fed through the multi-purpose apparatus.

In use, the process begins with a sheet or web of printed material being fed into the multi-purpose processing apparatus by a feed system. After a portion of the sheet or web is formed, it is advanced to a cutting and/or molding operation within the injection molding machine. As the formed portion is cut and/or molded, a new portion is advanced to the forming operation and formed simultaneously with the portion being cut and/or molded. The cutting operation can be set up to cut the sheet or web prior to forming, during forming, after forming, during molding, or after molding. The process yields multiple finished parts without having to manually handle the parts between processing steps.

As stated earlier, in a conventional process for producing in-mold decorated parts, numerous steps are involved. The present invention eliminates many of the steps by allowing the sheet or web of printed material to flow directly between a forming process, a cutting process, and/or a molding process without any manual intervention. Therefore, the typical steps required to produce an in mold decorated part before the part is injection molded, i.e., forming and cutting, are not necessary. Therefore, separate forming, cutting and injection molding operations are no longer required, as these operations are performed simultaneously within an injection molding machine.

Various other features, objects, and advantages of the invention will be made apparent to those skilled in the art from the accompanying drawings and detailed description thereof.

### BRIEF DESCRIPTION OF THE DRAWINGS

FIG. 1 is a side view of an injection molding machine including a multi-purpose processing apparatus constructed according to a first embodiment of the invention;

FIG. 2 is a side view of an injection molding machine including a multi-purpose processing apparatus constructed according to a second embodiment of the invention;

FIG. 3 is a perspective view of a heater assembly of a thermoforming tool attached to the apparatus of FIGS. 1 and 2;

FIG. 3A is an exploded perspective view of the heater assembly of FIG. 3;

FIG. 4 is a perspective view of a former assembly of the thermoforming tool attached to the apparatus of FIGS. 1 and 2;

FIG. 4A is an exploded perspective view of the former assembly of FIG. 4;

FIG. 5A is a partial cross-sectional side view of the heater assembly of FIG. 3;

FIG. 5B is a partial cross-sectional top view of the heater assembly of FIG. 3;

FIG. 5C is a partial cross-sectional front view of the heater assembly of FIG. 3;

FIG. 6A is a partial cross-sectional side view of the former assembly of FIG. 4;

FIG. 6B is a partial cross-sectional top view of the former assembly of FIG. 4;

FIG. 6C is a partial cross-sectional front view of the former assembly of FIG. 4;

FIG. 7 is a side view of the thermoforming tool with a substrate positioned between the former assembly and heater assembly during forming of the substrate;

FIG. 8 is a top view of a substrate with printing thereon prior to forming, cutting, and molding in accordance with the method and apparatus of the present invention;

FIG. 9 is a perspective view of the substrate of FIG. 8 after forming in accordance with the method and apparatus of the present invention;

FIG. 10 is a cross-sectional view of the formed substrate taken along line 10-10 of FIG. 9;

FIG. 11 is a perspective view of the substrate of FIG. 9 after cutting and molding in accordance with the method and apparatus of the present invention; and

FIG. 12 is a cross-sectional view of the molded substrate taken along line 12-12 of FIG. 11.

### DETAILED DESCRIPTION OF THE INVENTION

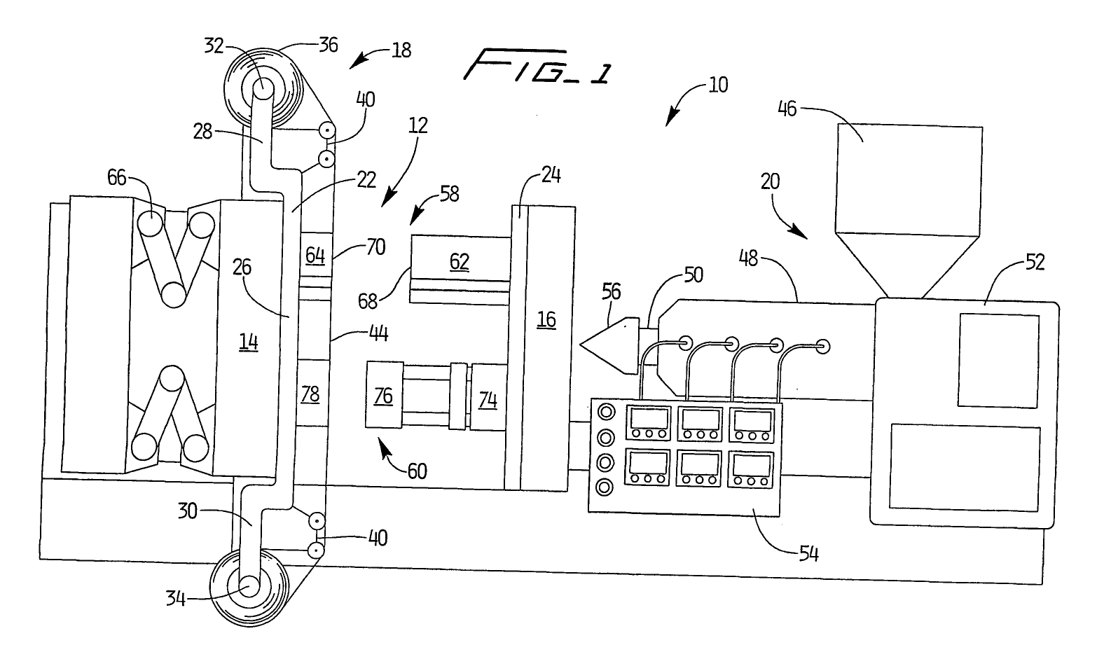

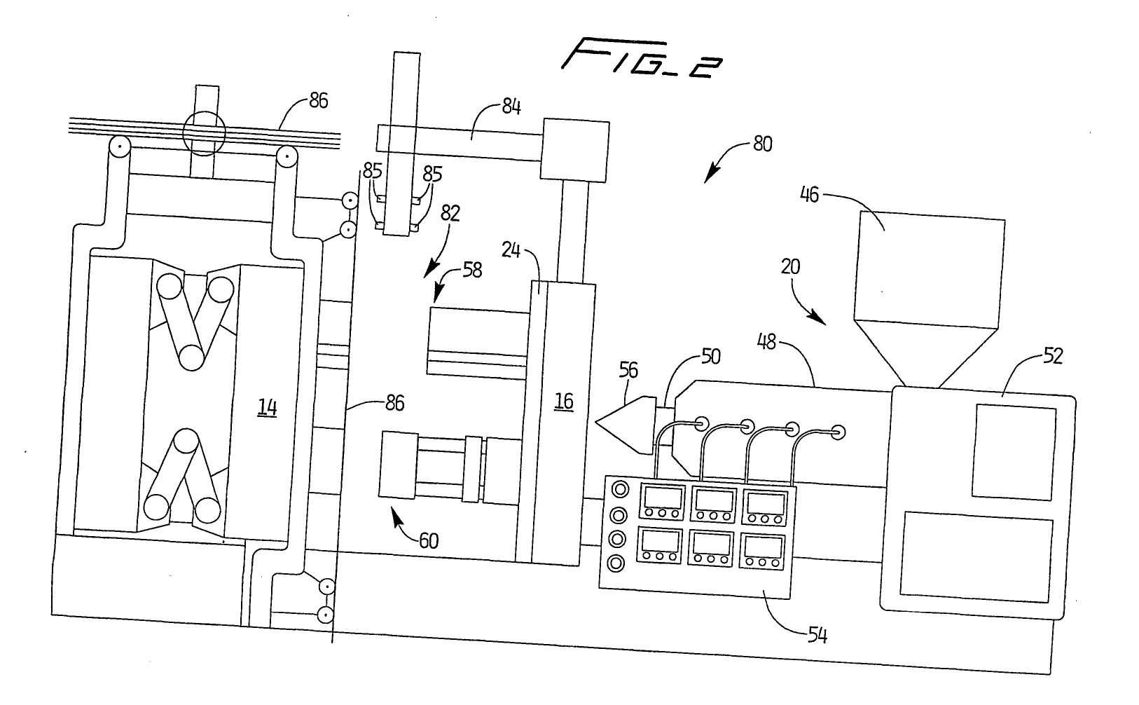

The present invention pertains to a multi-purpose processing apparatus 12 mounted to an injection molding machine 10, shown generally in FIGS. 1 and 2. The multi-purpose processing apparatus 12 is able to perform forming operations, cutting operations, and injection molding operations for manufacturing in-mold decorated parts on an injection molding machine 10. Using the method and apparatus of the present invention eliminates the need for three separate and distinct steps of forming, cutting, and injection molding, as well as eliminating separate forming machines and cutting machines, and eliminating pre-injection molding steps and costs associated with making in-mold decorating parts.

Referring first to FIG. 1, an injection molding machine 10 is shown including a multi-purpose processing apparatus 12 constructed in accordance with a first embodiment of the invention. Before modification as provided by the invention, the injection molding machine 12 is one as is known in the art, such as those manufactured by Van Dorn Demag Corporation, Cincinnati Milacron, Inc., or Engel Machinery, Inc. The injection molding machine 12 includes a movable platen 14, a stationary platen 16, a web feed system 18 for feeding a web of material through the multi-purpose processing apparatus 12, and an injection system 20 for injecting plastic resin into an injection mold as is known in the art.

The movable platen 14 includes a movable mounting plate 22 mounted to the surface of the movable platen 14. The stationary platen 16 includes a stationary mounting plate 24 mounted to the surface of the stationary platen 16 of the injection molding machine 10. The movable mounting plate 22 and stationary mounting plate 24 are standard mounting plates for use in injection molding machines. In the embodiment shown in FIG. 1, the stationary mounting plate 24 is rectangular in shape, while the movable mounting plate 22 includes a rectangular-shaped portion 26 substantially identical to the shape of the stationary mounting plate 24, with extensions 28, 30, on each end of the rectangular-shaped portion 26 for use with the web feed system 18.

The web feed system 18 is mounted to the movable mounting plate 22, and includes a top roll mount 32 attached to the end of the top extension 28, and a bottom roll mount 34 attached to the end of the bottom extension 30 of the movable mounting plate 22 for holding a supply of printed web material in roll form. A supply reel 36 of printed or decorated material 44 in roll form, is rotatably mounted to the top roll mount 32, while an end reel 38 is rotatably mounted to the bottom roll mount 34, to collect the waste if cutting is performed on the web material 44, or to retain the formed and molded parts, still in web form, if cutting is not performed. At least two tensioning mechanisms 40 of generally conventional construction are provided and positioned on the movable mounting plate 22 to feed and guide the printed web material 44 from the supply reel 36 through the multi-purpose processing apparatus 12 to the end reel 38.

The injection system 20 is used for injecting molten plastic resin into an injection mold on the injection molding machine. In the injection system 20, granular plastic material is supplied to a hopper 46 connected to a heating barrel 48 for melting the granular material into a molten resin. The heating barrel 48 includes a plasticating screw 50 inserted therein and rotated by a screw drive motor 52 which is controlled by an injection controller 54 for forcing the molten resin into the injection mold. The rotating plasticating screw 50 moves the molten resin through the heating barrel 48 and into an injection nozzle 56 at one end of the plasticating screw 50 for injecting the molten resin into the injection mold.

The multi-purpose processing apparatus 12 includes a forming tool 58 for performing a forming operation and an injection mold 60 for performing a simultaneous molding operation on the printed or decorated web of material 44. The forming tool 58 and the injection mold 60 are preferably mounted to the mounting plates 22, 24 of the movable platen 14 and the stationary platen 16. Alternatively, the forming tool 58 and the injection mold 60 may be mounted directly to the platen surfaces.

The forming tool 58 is generally positioned above or upstream of the injection mold 60. The forming tool 58 preferably includes two main parts, a former assembly 62 attached to the mounting plate 24 of the stationary platen 16, and a heater assembly 64 attached to the mounting plate 22 of the movable platen 14. The movable platen 14 is controlled by a clamping mechanism 66, which moves the movable platen 14 toward and away from the stationary platen 16. The former assembly 62 and the heater assembly 64 have opposing surfaces 68 and 70 for engaging the web material 44 during closing of the forming tool 58. The surfaces 68 and 70 face each other such that when the forming tool 58 is brought together, surfaces 68 and 70 substantially engage each other with the web material 44 in-between.

The injection mold 60 is positioned below or downstream of the forming mold portion 58. The injection mold 60 includes a core part 74 attached to the mounting plate 24 of the stationary platen 16, a center plate 76 mounted to the core part 74 with ejectors for ejecting a molded part, and a cavity part 78 attached to the mounting plate 22 of the movable platen 14. As is known in the art of injection molding, the mold components including the forming mold components are generally constructed of steel.

Generally at least one cutting operation is also performed when making deep drawn injection molded parts. In the present invention, a cutting operation may occur prior to the forming operation, during the forming operation when the forming tool parts are opening, between the forming and molding operations, during the injection molding when the mold halves are closing or opening, and/or after the injection molding operation.

Operation of the multi-purpose apparatus 12 begins with the supply reel 36 of printed or decorated web material 44 being fed through the tensioning mechanism 40 and into the forming tool 58 for forming portions of the material for making in-mold decorated parts. After the forming operation, the printed web material is advanced further, thereby feeding the just-formed part into the injection mold 60 and a non-formed part into the forming tool 58. The just-formed part is then injection molded in the injection mold 60, as is known in the art, while the newly advanced portion of printed material in the forming tool 58 is simultaneously formed.

In the injection molding process, the injection mold is filled with molten resin as the plasticating screw 50 moves forward, or leftward as depicted in FIG. 1, forcing molten resin into the closed mold, held closed by clamping pressure of approximately 50 to 2000 tons by the clamping mechanism 66. The molten resin is typically formed from granular plastic material, melted to between 350 and 900 degrees Fahrenheit, which is forced into the mold cavity at a pressure typically between 1,000 and 30,000 pounds per square inch (psi). After the cavity of the mold is full, additional plastic may be compressed into the cavity to help offset the shrinkage that typically occurs during cooling. The plastic in the mold is cooled by supplying coolant through cooling passages in the mold. During cooling, heat is drawn out of the plastic so that when the mold is opened the plastic part is completely formed into a solid piece. The cooling typically takes between 7 and 45 seconds, depending on the thickness of the part. When the molded part is cool enough to hold its shape, the mold is opened and the plastic part is ejected. The mold is closed and the cycle begins again.

FIG. 2 shows a second embodiment of an injection molding machine 80 including a multi-purpose processing apparatus 82 constructed in accordance with an alternative embodiment of the present invention The main difference between the two embodiments is that the first embodiment, shown in FIG. 1, includes a web feed system for feeding a continuous web of printed or decorated material through the multi-purpose processing apparatus, while the second embodiment includes a robotically indexed sheet feed system for feeding individual sheets or substrates of printed or decorated material through the multi-purpose processing apparatus. In this alternative embodiment, a plurality of individual sheets or substrates 86 are automatically fed into the injection molding machine 80 using a robot 84. The robot 84 is preferably a multi-axis servo robot manufactured specifically for use with injection molding machines that are known in the art. One such manufacturer of these robots is Engel Machinery, Inc. The robot 84 preferably includes part handling grippers 85 attached to the end of the robot for gripping the individual sheets or substrates 86 and advancing them through the multi-purpose processing apparatus 82 of the injection molding machine 80.

The injection molding machine 80 includes a movable platen 14, a stationary platen 16 and an injection system 20 for injecting plastic resin into the injection mold. The movable platen 14 and stationary platen 16 include mounting plates 22, 24 for mounting the multi-purpose processing apparatus including a forming tool 58 and an injection mold 60. A sheet of printed material 86 is positioned within the multi-purpose processing apparatus 82.

The injection system 20, like FIG. 1, includes a hopper 46 connected to a heating barrel 48 for melting granular plastic material into a molten resin. The heating barrel 48 includes a plasticating screw 50 inserted therein and rotated by a screw drive motor 52 which is controlled by an injection controller 54. The rotating plasticating screw 50 moves the molten resin through the heating barrel 48 and into an injection nozzle 56 at one end of the plasticating screw 50 for injecting the molten resin into the injection mold 60.

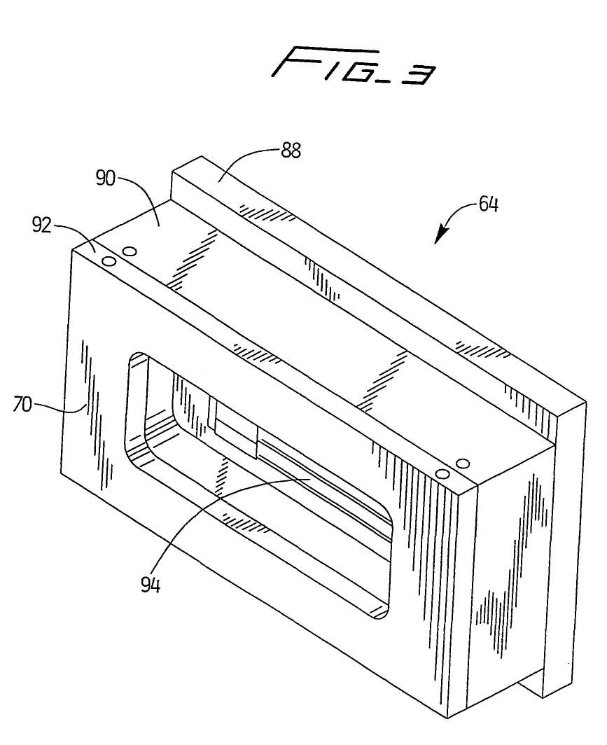

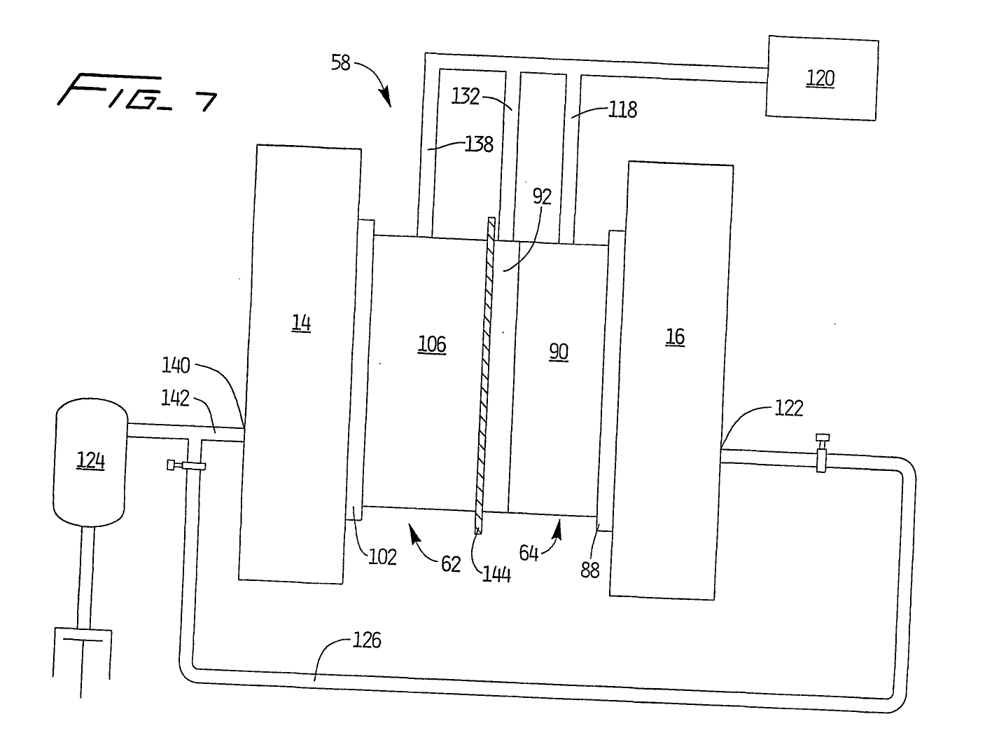

FIGS. 3, 3A, 4, 4A, 5A, 5B, 5C, 6A, 6B and 6C illustrate a plurality of detailed views of the former assembly 62 and the heater assembly 64 of the forming tool 58 of the multi-purpose processing apparatus 12, 82 shown in FIGS. 1 and 2. The forming tool 58 is preferably a thermoforming apparatus with a former assembly 62 attached to the stationary platen 16, and a heater assembly 64 attached to the movable platen 14. The former assembly 62 and the heater assembly 64 have opposing surfaces 68 and 70 for engaging a substrate 144 during closing of the forming tool 58. The surfaces 68 and 70 face each other such that when the former assembly 62 and heater assembly 64 are brought together, surfaces 68 and 70 substantially engage each other with the substrate 144 in-between as shown in FIG. 7.

The forming process of the present invention involves a thermoforming apparatus utilizing heating and cooling circuits to heat the substrate to near the glass transition temperature of the substrate material. The clamping pressure necessary for bringing former assembly 62 in contact with the heater assembly 64 is supplied by the clamping mechanism 66 of an injection molding machine 10, 80.

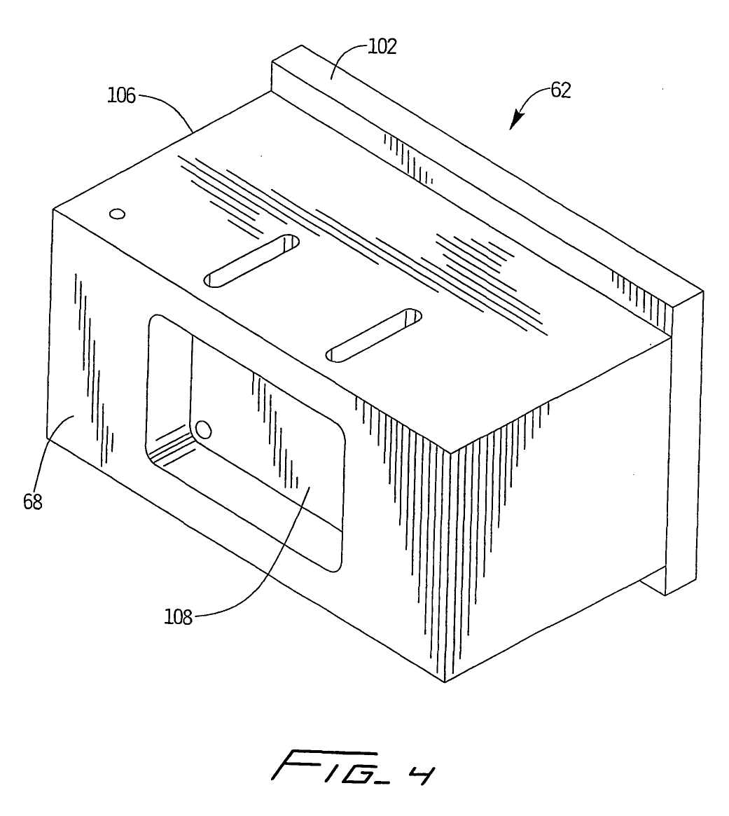

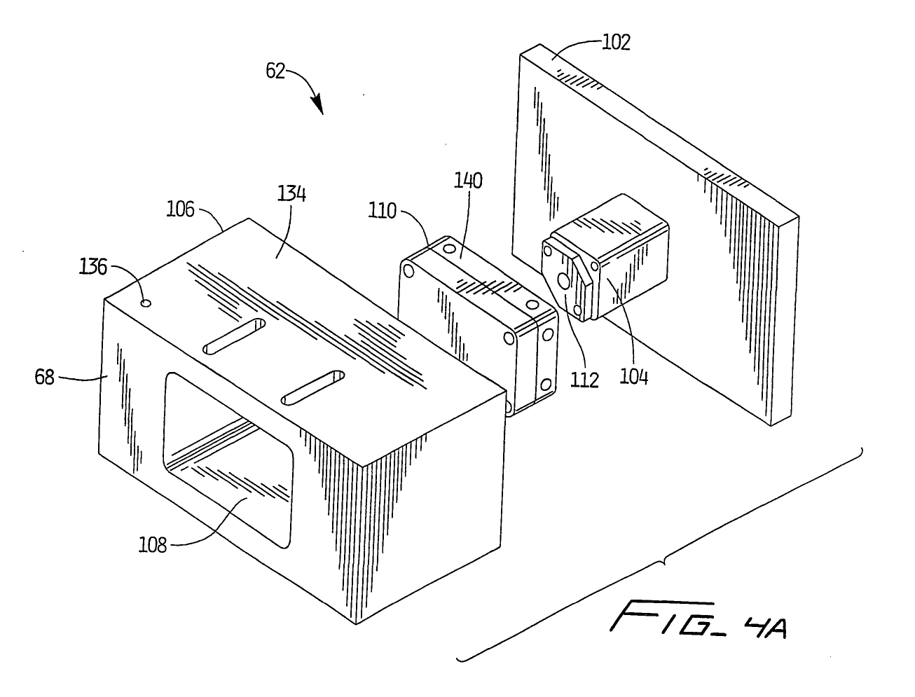

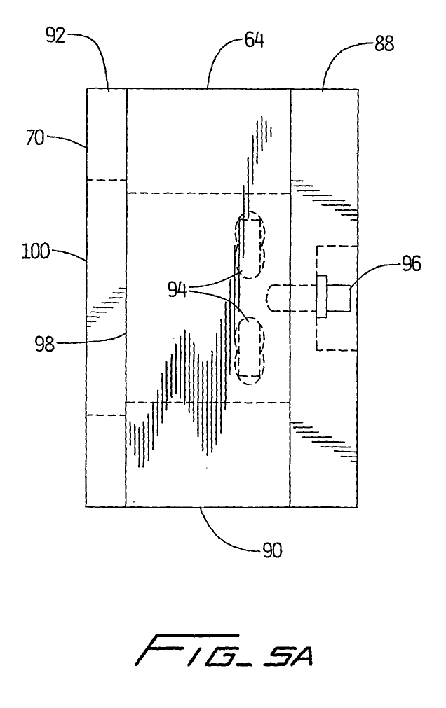

FIGS. 3, 3A, 5A, 5B, and 5C illustrate a more detailed view of the heater assembly 64 of the forming tool 58. The heater assembly 64 includes a base 88 having at least one heating element 94 and a temperature sensor 96 mounted thereto, a pressure vessel 90 coupled to the base 88 and a cooling vessel 92 coupled to the pressure vessel 90. The base 88, pressure vessel 90 and cooling vessel 92 are all connected together to form one side of the forming tool 58 referred to as the heater assembly 64. The pressure vessel 90 preferably consists of a rectangular shaped body 114 with a rectangular opening 98 extending therethrough. The rectangular shaped body 114 is preferably hollow so that cooling fluid, preferably water, may be introduced through a valve opening 116 in the body through a conduit 118 to a source of cooling fluid 120 as shown in FIG. 7. The pressure vessel 90 also includes a pressure port 122 for applying a pressure medium or vacuum in the opening 98 in the body. The pressure port 122 is coupled to a pressure/vacuum source 124 through a separate conduit 126 as shown in FIG. 7. The cooling vessel 92 similarly consists of a rectangular shaped body 128 with a rectangular opening 100 extending therethrough. The rectangular shaped body 128 is preferably hollow so that cooling fluid, preferably water, may be inserted through a valve opening 130 in the body through a conduit 132 to the source of cooling fluid 120 as shown in FIG. 7. The cooling fluid is used for maintaining and cooling the pressure and cooling vessels 90, 92 during heating of the substrate.

Traditional thermoformers use ceramic or quartz heating elements which are brought into close proximity with a substrate to heat it and then are retracted so as not to overheat or burn the substrate. These types of heating elements retain a great amount of heat, so much so that they often burn or overheat the substrate if left in close proximity with the substrate for too long a period of time. Additionally, the heating elements require the substrate to be cooled after forming which necessitates removing the substrate from the heating elements. The present invention does not require that the heating elements be brought into close proximity with the substrate and then retracted after heating. Instead, the present invention utilizes infrared heating elements that are allowed to remain in close proximity with the substrate because they are designed for rapid on/off heating. The heating elements do not retain much heat, so that when the heating element is turned on, the element has full heating energy, and when the heating element is turned off, the heat dissipates quickly. This will allow for heating of the substrate during the initial stages of forming. The heating elements are preferably carbon halogen infrared tube emitters. One manufacturer of such emitters is Heraeus Noblelight GmbH of Kleinostheim Germany.

Referring again to FIGS. 3A, 5A, 5B and 5C, in addition to the heating elements 94, the heater assembly 64 also includes a temperature sensor 96 located inside the assembly to detect the actual temperature of the substrate during heating, so that the substrate may be heated precisely to the glass transition temperature of the material. This is an improvement from most prior art thermoformers which use time to control heating of the substrate to its glass transition temperature. Time is often an imperfect gauge of heating temperature. In addition, the amount of heat transferred to the substrate often varies due to the build up of heat in the equipment, variation in cycle time, and changes in the external environment due to ambient temperature variations and external air flow, etc. Thus, being able to control the thermoforming process based on actual substrate temperature will increase the repeatability of the thermoforming process dramatically. The temperature sensor used in the present invention is preferably a minIRT 480 series miniature infrared thermometer manufactured by IRCON, Inc. of Niles, Ill. However, other infrared temperature sensors, such as those manufactured by Omega Engineering, Inc. of Stamford, Conn., may also be used.

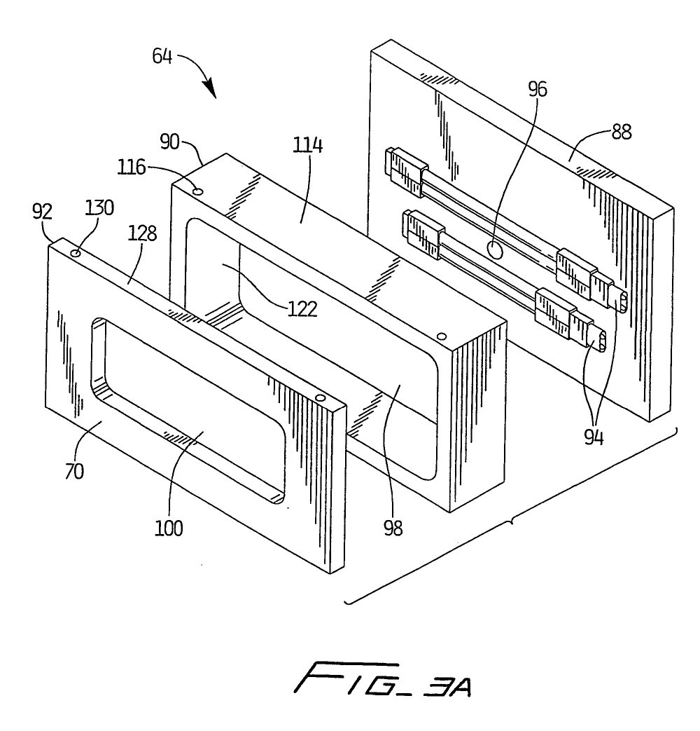

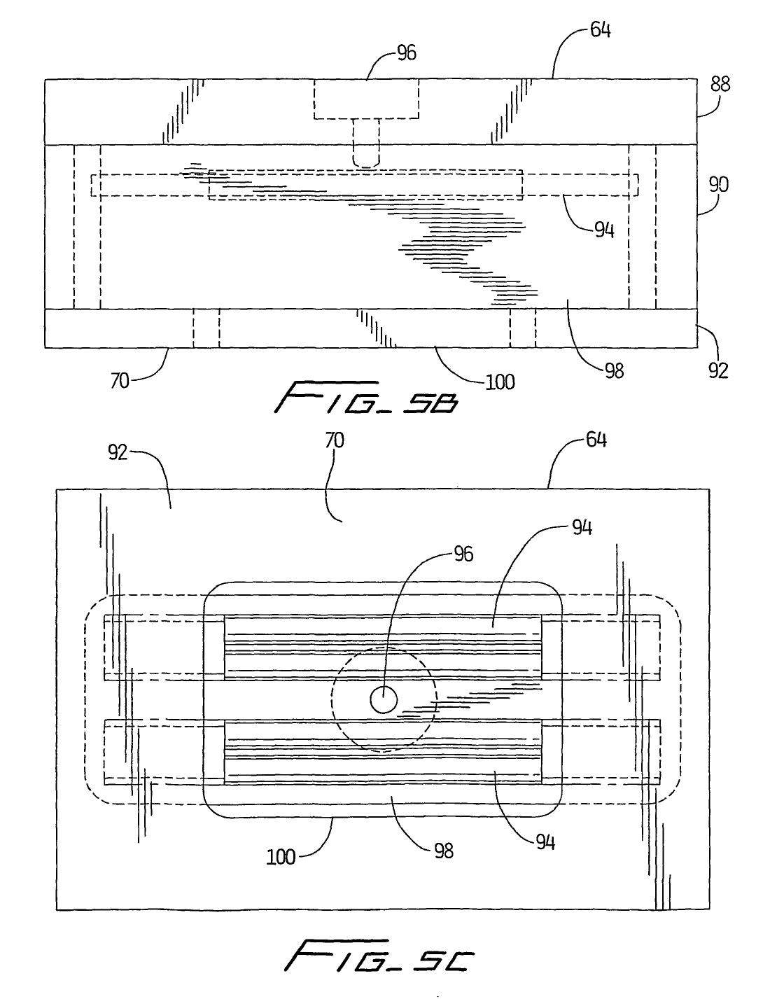

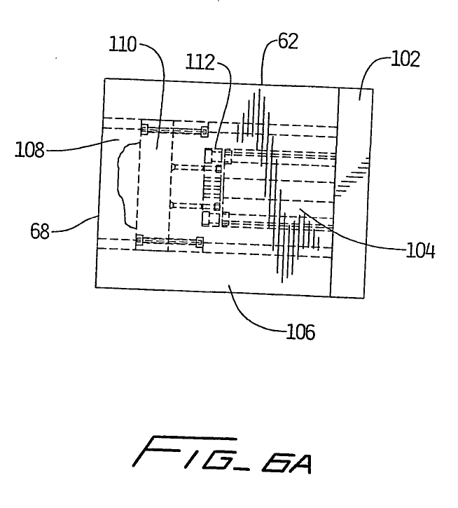

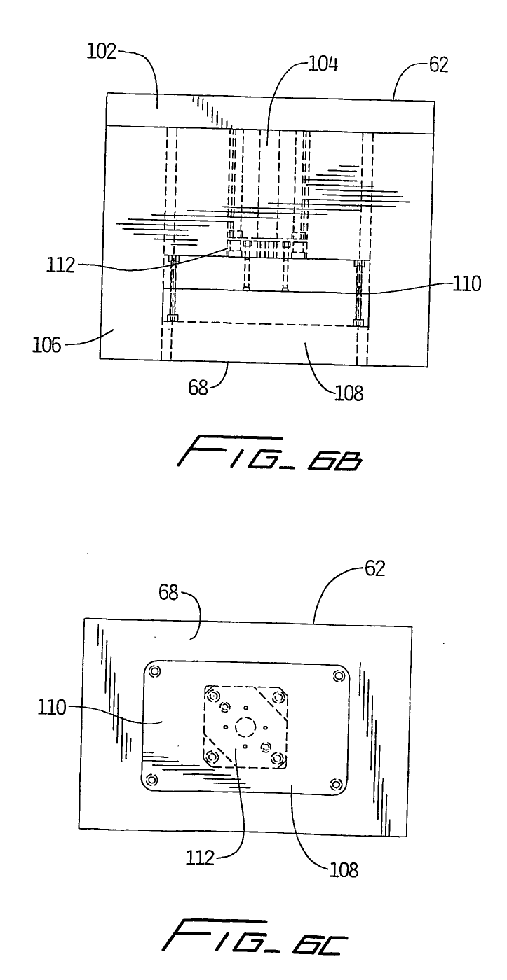

FIGS. 4, 4A, 6A, 6B and 6C illustrate a more detailed view of the former assembly 62 of the forming tool 58. The former assembly 62 includes a base 102 having a forming mold actuator 104 mounted thereto with a mold interface coupling 112 attached to the end of the forming mold actuator 104 for removably attaching a forming mold 110 thereto. The former assembly 62 also includes a forming vessel 106 which is connected to the base 102 to form the other side, opposite the heater assembly 64, of the forming tool 58. The forming vessel 106 preferably consists of a rectangular shaped body 134 with a rectangular opening 108 allowing the forming mold 110 to extend through the forming vessel 106. The rectangular shaped body 134 is preferably hollow so that cooling fluid, preferably water, may be inserted through a valve opening 136 in the body through a conduit 138 to a source of cooling fluid 120 as shown in FIG. 7. The forming mold 110 also includes a pressure port 140 for applying a pressure medium or vacuum in the forming mold 110 during forming of the substrate. The pressure port 140 is coupled to a pressure/vacuum source 124 through a separate conduit 142 as shown in FIG. 7.

FIG. 7 is a side view of the thermoforming tool 58 with a substrate 144 positioned between the former assembly 62 and the heater assembly 64 during forming of the substrate. As indicated above, in this embodiment the heater assembly 64 is attached to the movable platen 14 while the former assembly 62 is attached to the stationary platen 16. However, the arrangement could be reversed such that the former assembly 62 is attached to the movable platen 14 and the heater assembly 64 is attached to the stationary platen 16. The former assembly 62 and the heater assembly 64 are brought together with the substrate 144 in-between by the clamping mechanism 66 of an injection molding machine 10, 80. The surfaces 68 and 70 of the former assembly 62 and heater assembly 64 face each other such that when the former assembly 62 and heater assembly 64 are brought together, surfaces 68 and 70 substantially engage the substrate 144. In the position shown, the heating elements 94 are in close proximity with the substrate 144 to heat the substrate 144 to near its glass transition temperature which is a known temperature. The temperature sensor 96 continuously monitors the temperature of the substrate 144 and generates a signal to turn off the heating elements 94 when the substrate 144 reaches its glass transition temperature. The forming mold 110 is then moved into position against the heated substrate 144 by the forming mold actuator 104. The forming mold actuator 104 may be pneumatically, hydraulically or electrically powered to move the forming mold 110 into and out of the forming chamber. To form the heated substrate 144 against the forming mold 110, a vacuum is applied to the forming mold 110 through the mold cavity. In addition, positive pressure of approximately 20-400 psi may be applied to the pressure vessel 90 through the forming chamber to enhance the forming capability of the thermoforming apparatus. The heating elements 94 are turned off and the substrate 144 is cooled by cooling fluid pumped and flowing through the pressure and cooling vessels 90, 92. The formed substrate is now ready to be injection molded in the injection mold 60.

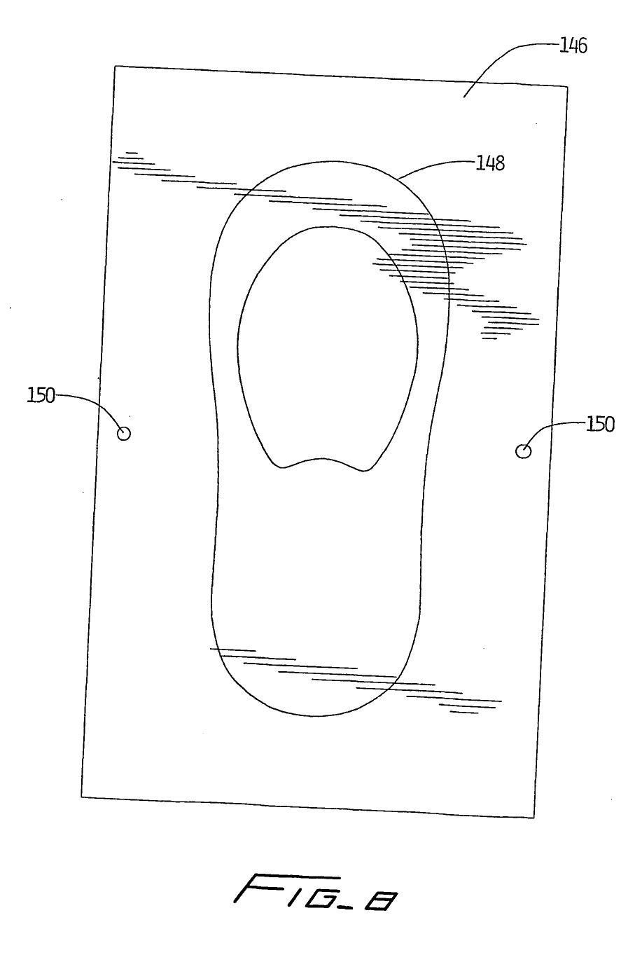

FIGS. 8-12 illustrate the various stages of producing an in-mold decorated part. FIG. 8 shows a substantially flat substrate 146 having markings 148 of a finished product and two indexing holes 150 for properly registering the substrate 146 on the injection molding machine of the present invention. The substrate 146 is typically printed or decorated with graphics such as letters, numbers, designs or other markings by various printing methods, such as silk screen printing, offset printing, flexographic printing, painting, digital printing, as well as other methods. Typically, both the front and back surfaces of the substrate 146 can be printed or decorated. The substrate 146 is typically flat before it is placed into a forming tool or an injection mold. The substrate 146 is preferably made of a plastic material, but may be made of other materials, and is typically supplied in sheet or roll form varying in thickness from 0.005 inch to 0.06 inch. The plastic material comprising the substrate may include polypropylene, polycarbonate, acrylic, vinyl, polyester, polystyrene, acrylonitrile butadiene styrene (ABS), polyethylene and others.

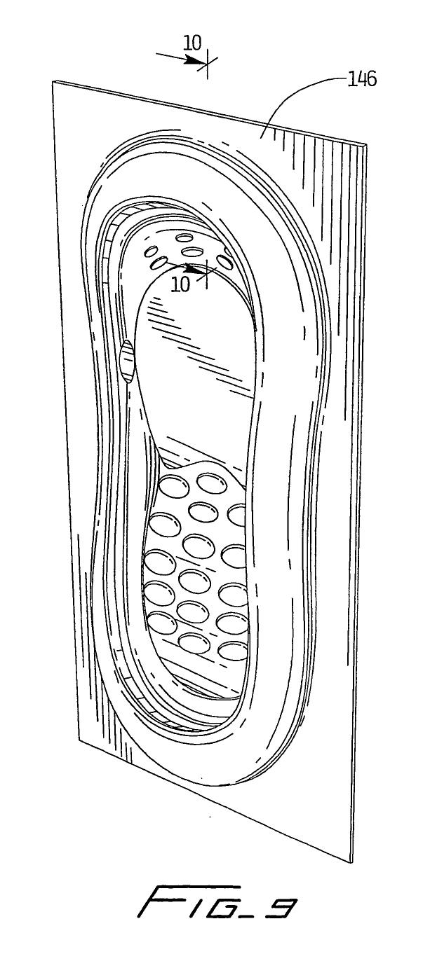

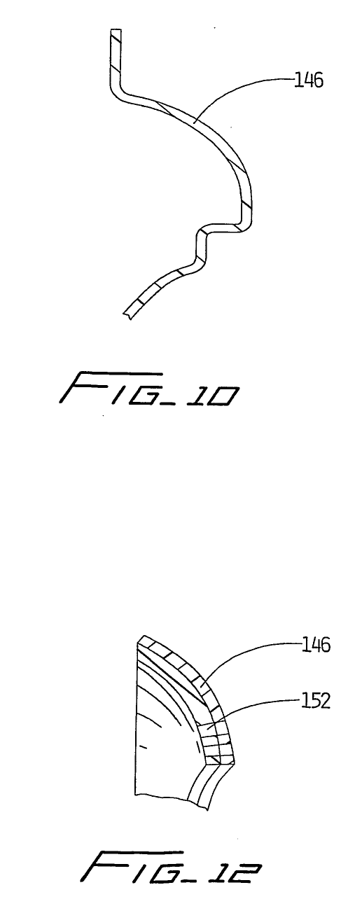

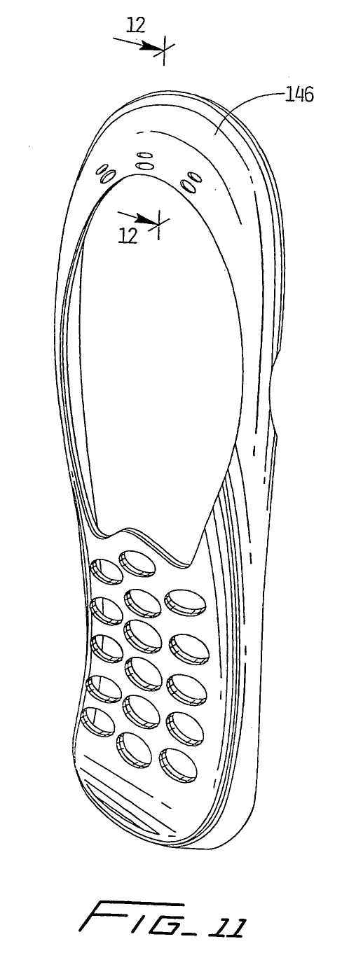

As next shown in FIG. 9, the flat substrate 146 is placed into the forming tool of the invention and formed by a pressure medium acting on the substrate to force the substrate against the surface of the forming tool insert. In this example, the forming tool insert is in the shape of a cellular telephone cover. Therefore, the substrate 146 takes the shape of a cellular phone cover, as shown in FIG. 9. A cross-sectional view of a portion of the formed substrate 146 is shown in FIG. 10. At this point in the process, the substrate 146 may also be pattern-cut e.g. by die cutting, along cut-lines to remove excess material, provide cut-outs, and define the perimeter of the final product. In the case of multiple pieces connected to a common web or matrix sheet substrate, the pattern-cutting step separates such pieces from the web to provide separate individual pieces, which are placed or fed into an injection mold. The pattern-cut substrate will appear similar to the finished product shown in FIG. 11.

After the forming operation, FIGS. 9 and 10, the substrate 146 is then placed or fed into an injection mold for an injection molding operation. During injection molding, an additional layer of material 152 is formed on the back or front surface of the substrate 146 as shown in FIGS. 11 and 12. FIG. 12 is a cross-sectional view of the formed, cut and injection molded substrate 146. The finished product, a cellular phone cover, is just one example of what one may produce using the method and apparatus of the present invention.

While the invention has been described with reference to preferred embodiments, those skilled in the art will appreciate that certain substitutions, alterations, and omissions may be made without departing from the spirit of the invention. Accordingly, the foregoing description is meant to be exemplary only and should not limit the scope of the invention set forth in the following claims.

1. A multi-purpose processing apparatus, comprising:
a thermoforming portion, capable of performing a forming operation on a substrate, the thermoforming portion mounted on an injection molding machine;
an injection molding portion, capable of performing an injection molding operation on said substrate, the injection molding portion mounted on the injection molding machine; and
a feed system for advancing the substrate from the thermoforming portion to the injection molding portion.

2. The apparatus of claim 1 further comprising a cutting portion positioned on the injection molding machine.

3. The apparatus of claim 1 wherein the forming operation is performed on one part of the substrate substantially simultaneously with the injection molding operation being performed on another part of the substrate.

4. The apparatus of claim 1 wherein the thermoforming portion includes a heater assembly on one side thereof and a former assembly on an opposite side thereof.

5. The apparatus of claim 4 wherein the heater assembly includes at least one carbon halogen infrared heating element for heating the substrate.

6. The apparatus of claim 5 wherein the heater assembly further includes at least one infrared temperature sensor for continuously monitoring the temperature of the substrate during heating.

7. The apparatus of claim 4 wherein the heater assembly includes a pressure vessel having an opening extending therethrough to form a first portion of one side of a forming chamber, the pressure vessel coupled to a pressure source and a cooling source.

8. The apparatus of claim 7 wherein the heater assembly further includes a cooling vessel having an opening extending therethrough to form a second portion of one side of the forming chamber, the cooling vessel coupled to the cooling source.

9. The apparatus of claim 8 wherein the cooling vessel is connected to one side of the pressure vessel and the other side of the pressure vessel is connected to a base to form the heater assembly with one side of the forming chamber enclosed within the cooling vessel and the pressure vessel.

10. The apparatus of claim 4 wherein the former assembly includes a forming mold removably connected to a base by a forming mold actuator, the forming mold coupled to a vacuum source.

11. The apparatus of claim 10 wherein the former assembly further includes a forming vessel having an opening extending therethrough to form the opposite side of a forming chamber, the forming vessel coupled to a cooling source.

12. The apparatus of claim 11 wherein the forming vessel is connected to the base to form the former assembly with the opposite side of the forming chamber enclosed within the forming vessel.

13. The apparatus of claim 1 wherein the feed system is a web feed system for feeding a web of material through the multi-purpose processing apparatus.

14. The apparatus of claim 1 wherein the feed system is a robotically indexed feed system having a robot for advancing individual sheets or substrates through the multi-purpose processing apparatus.

15. A multi-purpose processing apparatus, comprising:
a thermoforming portion, capable of performing a forming operation on a substrate, the thermoforming portion mounted on an injection molding machine;
a cutting portion, capable of performing a cutting operation on the substrate, the cutting portion mounted on the injection molding machine;
an injection molding portion, capable of performing an injection molding operation on the substrate, the injection molding portion mounted on the injection molding machine; and
a feed system for moving the substrate to be processed from the thermoforming portion to the injection molding portion.

16. The apparatus of claim 15 wherein the feed system advances the substrate from the thermoforming portion to the cutting portion, and to the injection molding portion.

17. The apparatus of claim 15 wherein the feed system is a web feed system for feeding a web of material through the multi-purpose processing apparatus.

18. The apparatus of claim 15 wherein the feed system is a robotically indexed feed system having a robot for advancing individual sheets or substrates through the multi-purpose processing apparatus.

19. The apparatus of claim 15 wherein the thermoforming portion includes a heater assembly on one side thereof and a former assembly on an opposite side thereof.

20. The apparatus of claim 19 wherein the heater assembly includes at least one carbon halogen infrared heating element for heating the substrate.

21. The apparatus of claim 19 wherein the heater assembly further includes at least one infrared temperature sensor for monitoring the temperature of the substrate during heating.

22. A method of manufacturing a formed substrate using an injection molding machine, the method comprising the steps of:
applying printing or graphics to a substrate;
advancing the substrate into a forming tool;
closing the forming tool around the substrate;
heating the substrate;
monitoring the temperature of the substrate;
advancing a forming mold into position adjacent the substrate;
applying a vacuum to the forming mold to form the substrate against the forming mold;
cooling the substrate;
opening the forming tool from around the substrate; and
advancing the substrate from the forming tool.

23. The method according to claim 22 wherein the forming tool includes a former assembly on one side thereof and a heater assembly on the opposite side thereof.

24. The method according to claim 23 wherein opposing surfaces of the former assembly and the heater assembly engage the substrate therebetween.

25. The method according to claim 23 wherein the former assembly is mounted to a stationary platen on the injection molding machine and the heater assembly is mounted to a movable platen on the injection molding machine.

26. The method according to claim 23 wherein the former assembly is mounted to a movable platen on the injection molding machine and the heater assembly is mounted to a stationary platen on the injection molding machine.

27. The method according to claim 23 wherein the heater assembly includes at least one heating element for heating the substrate.

28. The method according to claim 23 wherein the heater assembly includes a temperature sensor for monitoring the temperature of the substrate.

29. The method according to claim 22 wherein the substrate is heated to its glass transition temperature.

30. The method according to claim 22 further comprising the step of applying a pressure medium to a pressure chamber within the heater assembly to facilitate forming of the heated substrate.

31. The method according to claim 30 wherein the pressure medium is between 20 and 400 psi.

32. The method according to claim 27 wherein the heating element is a carbon halogen infrared heating element.

33. The method according to claim 28 wherein the temperature sensor deactivates the heating element as the heated substrate reaches its glass transition temperature.

34. A method of manufacturing an injection molded part integral with a formed decorated substrate using an injection molding machine, the method comprising the steps of:
decorating a substrate by applying printing or graphics thereto;
advancing the decorated substrate into a forming tool between a former assembly and a heater assembly of the forming tool;
closing the forming tool around the decorated substrate, such that the surfaces of the former assembly and the heater assembly engage the substrate therebetween;
heating the decorated substrate with at least one heating element located within the heater assembly;
advancing a forming mold adjacent the heated decorated substrate;
applying a vacuum to the forming mold to form the heated decorated substrate against the forming mold;
cooling the formed decorated substrate;
opening the forming tool from around the formed decorated substrate;
advancing the formed decorated substrate from the forming tool into an injection mold;
closing the injection mold;
injecting molten resin into the closed injection mold;
cooling the injection mold; and
opening the injection mold to yield an injection molded part integral with the formed decorated substrate.

35. The method according to claim 34 further comprising the step of cutting the formed decorated substrate.

36. The method according to claim 34 further comprising the step of monitoring the temperature of the decorated substrate with a temperature sensor located within the heater assembly.

37. The method according to claim 34 wherein the former assembly and the heater assembly have opposing surfaces that substantially engage the advancing substrate between the opposing surfaces.

38. A method of forming, cutting, and injection molding a decorated substrate using a multi-purpose processing apparatus, the method comprising the steps of:
thermoforming a first portion of the substrate in a forming mold mounted on an injection molding machine;
advancing the first portion of the substrate after thermoforming to an injection mold mounted on an injection molding machine while simultaneously advancing a second portion of the substrate to the forming mold for thermoforming; and
injection molding the first portion of the substrate in the injection mold while simultaneously thermoforming the second portion of the substrate in the forming mold.

39. The method according to claim 38 further comprising the step of cutting the first portion of the substrate while closing the forming mold.

40. The method according to claim 38 further comprising the step of cutting the second portion of the substrate while closing the forming mold.

41. The method according to claim 38 further comprising the step of cutting the first portion of the substrate after closing the forming mold.

42. The method according to claim 38 further comprising the step of cutting the first portion of the substrate while opening the forming mold.

43. The method according to claim 38 further comprising the step of cutting the second portion of the substrate while opening the forming mold.

44. The method according to claim 38 further comprising the step of cutting the first portion of the substrate while closing the injection mold.

45. The method according to claim 38 further comprising the step of cutting the first portion of the substrate after closing the injection mold.

46. The method according to claim 38 further comprising the step of cutting the first portion of the substrate while opening the injection mold.

47. The method according to claim 38 further comprising the step of cutting a portion of the substrate in a cutting tool mounted on the injection molding machine, substantially simultaneously with the thermoforming and injection molding steps.

48. The method according to claim 38 wherein the substrate is advanced through the multi-purpose processing apparatus by a robotic feed system.
